(19) United States
(12) Patent Application Publication
(10) Pub. No.: US 2005/0082909 A1
(43) Pub. Date: Apr. 21, 2005

(54) Pedal feel emulator mechanism for brake by wire pedal

(76) Inventors: Crista M. Constantakis, Allen Park, MI (US); Srini Sundaresan, Rochester Hills, MI (US); Casimir R. Kiczek, Gray, GA (US)

Correspondence Address: John R. Benefiel;Suite 100 B, 280 Daines Street, Birmingham, MI, 48009, US

(21) Appl. No.: 10/969,328

(22) Filed: Oct. 20, 2004

Related U.S. Application Data
(60) Provisional application No. 60/512,844, filed on Oct. 20, 2003.

(51) Int. Cl. B60T 13/66

(52) U.S. Cl. 303/20

(57) ABSTRACT

A brake pedal emulator mechanism includes a foamed plastic elastomeric piece compressed by a brake pedal which piece has a variable spring rate and produces hysteresis when compressed to emulate the brake pedal feel of a conventional hydraulic brake system. The foamed plastic may comprise microcellular urethane or a foamed silicone elastomer. Various combinations of the foamed plastic piece with mechanical springs, solid elastomeric pieces, or gas springs can be used to create a particular reaction force characteristic, as well as various shapes of the foamed plastic elastomeric piece itself.

### CROSS REFERENCE TO RELATED APPLICATIONS

This application claims the benefit of U.S. provisional application Ser. No. 60/512,844, filed on Oct. 20, 2003.

### BACKGROUND OF THE INVENTION

This invention concerns devices for replicating the pedal “feel” of a conventional hydraulic brake in an electronically operated brake systems, often referred to as “brake by wire” systems. Such brake by wire systems have been proposed in which displacement and force sensors are associated with the pedal which generate signals used to control the operation of the wheel brakes. In operating a brake by wire system, a driver typically feels more comfortable when the pedal feel is similar to the pedal feel of a conventional brake system, and thus designers have sought to achieve this.

In addition, it is desirable that the sensed foot pressure corresponds to a similar braking effect in both conventional and brake by wire brake systems.

A major characteristic of conventional hydraulic brake systems pedal feel is the particular hysteresis effect exhibited by those systems, in that the pedal effort required to apply the brake greatly exceeds the reaction force sensed when the pedal is released. A second characteristic is a very slow rate of increase in pedal force in the beginning stage of pedal travel, followed by an exponential increase in sensed pedal force as the brake pedal approaches its fully applied position. Thus, any pedal feel emulator device must provide both a hysteresis effect and an initial linear gradual increase in pedal force with a subsequent exponential increase in pedal resistance as the pedal moves through its final range of movement. (See diagram in FIG. 3 showing an Apply curve A, and a release curve B).

Hysteresis has been produced in the context of an electronic control for an accelerator pedal, as described in U.S. Pat. No. 6,360,631 B1, incorporated herein by reference, by a hysteresis device which induces increasing frictional resistance to pedal movement. The hysteresis device is secured to the support structure and includes a plunger engaging the pedal arm and is movable within a chamber between an extended position and a depressed position upon rotation of the pedal arm. A pair of coaxial compression springs resiliently bias the plunger to the extended position. The chamber forms a first friction surface and the plunger has a plurality of prongs forming a second friction surface engagable with the first friction surface to resist pivotal movement of the pedal arm. Friction between the first and second friction surfaces, that is resistance to movement of the plunger, increases as the plunger moves from the extended position toward the depressed position. Variable friction is obtained because the prongs form angled surfaces engaging the spring for wedging the prongs in a radially outward direction to engage the first and second friction surfaces together with increasing force as the springs are compressed. This frictional resistance creates hysteresis in that the friction that must be overcome to move the pedal is substantially more than the force required to merely hold the pedal in a depressed position, simulating the feel of a mechanical accelerator pedal.

To simulate the proper pedal feel for a brake by wire system presents substantially different requirements from an electronic throttle control due to these described different pedal feel characteristics of a hydraulic brake system.

That is, in the case of brake pedal sensed forces in a hydraulic brake system, there is a slow, linear increase in pedal reaction force as the brake pedal is first applied. In the approximate midrange of pedal travel, resistance begins to increase exponentially which exponential increase continues until the fully applied condition of the brakes is reached.

After release, the pedal reaction force initially declines very sharply, and thereafter declines linearly at a low rate.

Thus, there is a complex relationship between the pedal motion and sensed pedal reaction force and there also is a hysteresis effect in that the apply force is less than the return force due to the loss of energy in a hydraulic system.

It is the object of the present invention to provide a simple mechanism for enabling the pedal feel in a hydraulic brake system for use in a brake by wire brake system.

### SUMMARY OF THE INVENTION

The above object as well as other objects which will become apparent upon a reading of the following specification and claims is achieved by a simple, reliable emulator mechanism which causes the brake pedal motion to compress a resiliently compressible foamed plastic elastomeric piece in such a way as to achieve the complex relationship between pedal motion and sensed resistance and also to provide the necessary hysteresis effect which is produced by the pedal for operating a conventional hydraulic brake system. The foamed plastic elastomeric piece provides an increased rate of increase in reaction force after the voids therein are substantially collapsed, and also can be easily formulated to provide hysteresis.

In a modified version, a mechanical spring-hysteresis device as described in U.S. Pat. No. 6,360,631 B1 is combined with the foamed plastic elastomeric piece, both compressed by the brake pedal.

In another approach, a foamed plastic elastomeric piece having sufficient inherent hysteresis is combined with a mechanical spring to eliminate the need for a separate hysteresis device while being more easily matched to a force-travel function of a conventional hydraulic brake system pedal.

The spring may also be a gas spring or solid elastomeric piece which may be compressed in series with the foamed elastomeric piece or in a staged successive manner by the design of a brake pedal actuated plunger.

In another approach, a hydraulic resistance device may be operated with the plunger compressing a foamed plastic elastomeric piece.

### DESCRIPTION OF THE DRAWINGS

FIG. 1 is a pictorial view of a brake pedal assembly including a pedal feel emulator mechanism according to the present invention.

FIGS. 1A-1, 1A-2 and 1A-3 are sectional views of a first embodiment of a pedal feel emulator mechanism according to the present intention in success stages of brake pedal application.

FIG. 1B is a sectional view of a second embodiment of a pedal feel emulator mechanism according to the invention.

FIG. 1C is a sectional view of a third embodiment of a pedal feel emulator mechanism according to the invention.

FIG. 1D is a sectional view of a fourth embodiment of a pedal feel emulator mechanism according to the invention.

FIG. 1E is a sectional view of a fifth embodiment of a pedal feel emulator mechanism according to the invention.

FIG. 2 is a side view of a special shape of an elastomeric piece used in the emulator mechanism according to the present invention.

FIG. 2A is an end view of the elastomeric piece shown in FIG. 2.

FIG. 2B is an end view of an alternative shape of the elastomeric piece shown in FIG. 2.

FIG. 2C is an end view of an another alternative shape of the elastomeric piece shown in FIG. 2.

FIG. 2D is a side view of the another alternative form of the elastomeric piece shown in FIG. 2.

FIG. 2E is partially sectional view of yet another embodiment of a pedal feel emulator mechanism according to the invention.

FIG. 3 is a plot of pedal load versus pedal stroke created by a pedal feel emulator device according to the invention.

FIG. 4 is several plots of pedal force versus pedal stroke produced by several variations of pedal feel emulator mechanisms according to the invention.

FIG. 5A is a diagram of a brake pedal assembly and another embodiment of a pedal feel emulator device according to the invention.

FIG. 5B is a diagram of a brake pedal assembly and is yet another embodiment of a pedal feel emulator device according to the invention.

FIG. 5C is a diagram of a brake pedal assembly and is still another embodiment of a pedal feel emulator device according to the invention.

FIG. 5D is a diagram of a brake pedal assembly and is yet another embodiment of a pedal feel emulator device according to the invention.

FIG. 6 is a plot of a desired pedal load versus displacement and of pedal load versus displacement produced by an emulator device according to the present invention.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

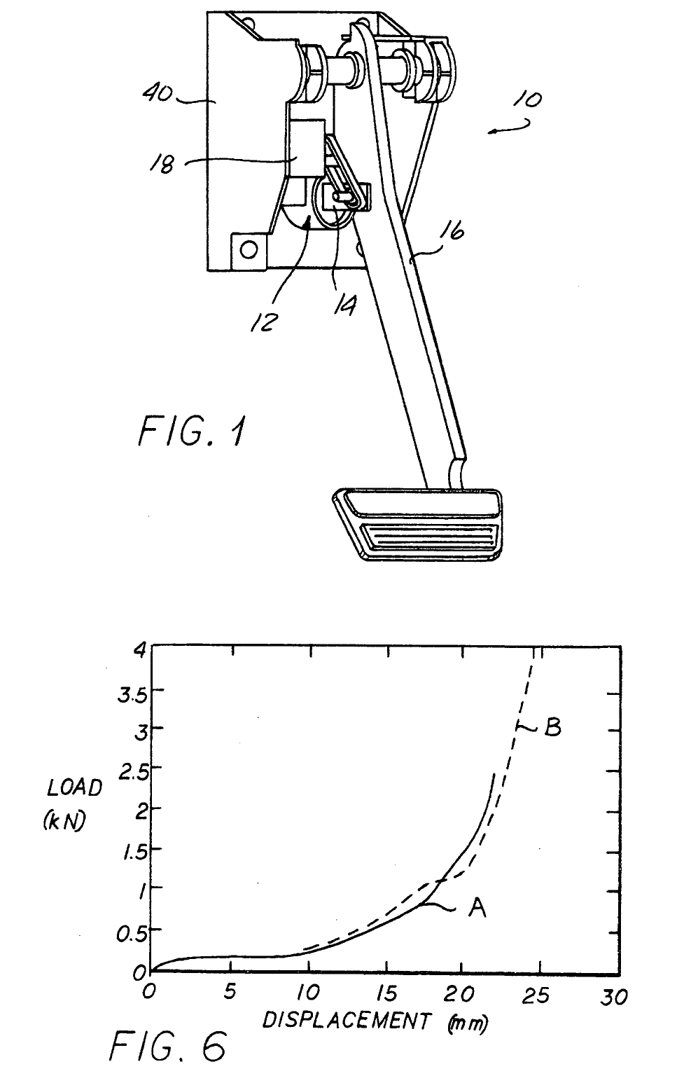

FIG. 1 shows a view of a brake pedal assembly 10 which includes a brake pedal feel emulator device 12 for use with an electronic brake by wire system. A plunger clevis 14 is pinned to the brake pedal 16 and operates the brake pedal emulator mechanism 12. The brake pedal 16 also drives a position sensor 18 to generate a signal used by the brake by wire system (not shown) in the well known fashion.

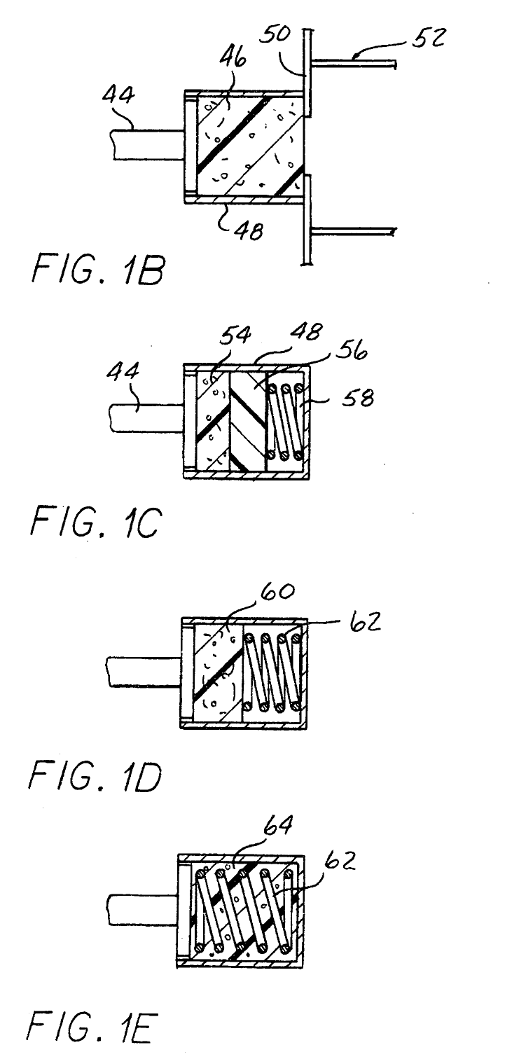

Referring to FIG. 1A-1, the emulator mechanism 12 includes a foamed plastic elastomeric piece 20 confined between two plates 22 in a chamber 26 to be compressed by a plunger 44 moved in advance and return directions by the pedal movement. The foamed plastic elastomer piece 20 may be combined in series with a separate hysteresis device comprised of a pair of coaxial springs 20, 32 confined in a chamber 36 and a plunger 34 as described in detail in U.S. Pat. 6,360,631B1 and as represented here in FIGS. 1A-1, 1A-2, 1A-3, to achieve the desired pedal reaction force characteristics over the complete range of pedal travel. The springs 30, 32 of the hysteresis device of the '631 patent are readily compressible to create a slow gradual increase in pedal force at the beginning of pedal travel, to provide part of the desired pedal feel characteristics.

The foamed plastic elastomeric piece 20 may be comprised of a urethane foam material. Elastomers such as urethane foam have by nature a hysteresis property in that, when they are compressed they do not return all the energy that was applied. This is because elastomers consist of an elastic portion which stores energy and returns it, and a viscous portion which captures energy and converts it to heat. In fact, the amount of hysteresis found in an elastomeric urethane can be controlled by the manufacturer because the ratio of the elastic component to the viscous component can be altered by chemical manipulation during compounding. This means that using a urethane elastomer piece 20 with the correct chemical properties placed in series with the hysteresis device 28 can produce the desired characteristics of a very gradual initial increase in reaction force with a subsequent much sharper increase in force.

One such urethane elastomeric material is a micro-cellular urethane. This material has tiny voids which when increasingly compressed to be collapsed causes the material to become more solid and harder to compress. This creates the exponential increase in loading force that is a required feature of the emulator mechanism. This urethane material also exhibits a significant degree of hysteresis.

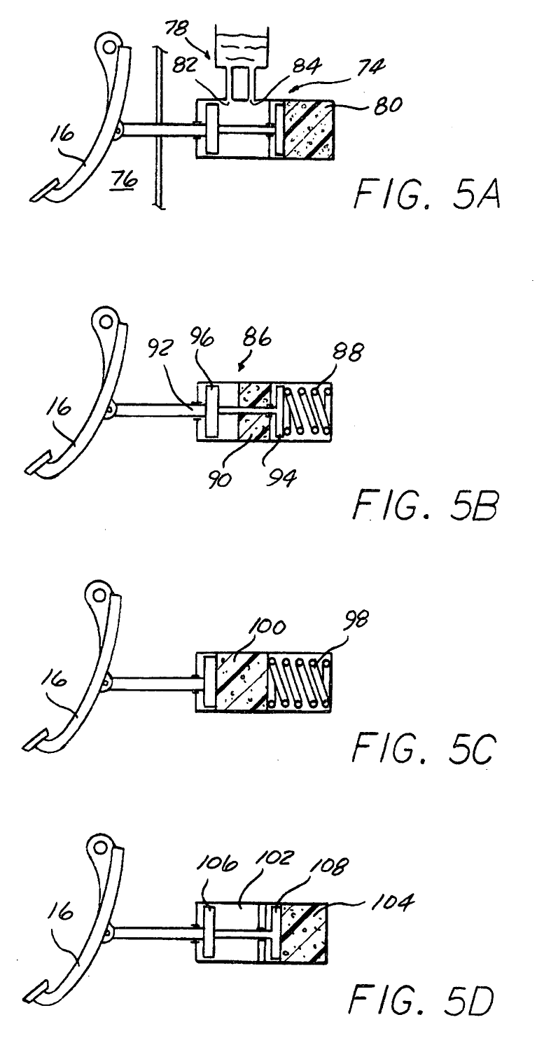

A micro-cellular urethane elastomeric piece 20 can be tailored to meet the load versus travel relationship of a brake pedal by altering the density of the material and changing the shape of the elastomeric piece 20. This change in material or shape may also have an influence on the compression versus deflection relationship. FIG. 6 shows how closely the force-displacement curve A of such material may be made to match a desired force-displacement curve B.

The components may be placed in series in the chamber 26 that is molded inside a plastic mounting bracket as shown in FIG. 1.

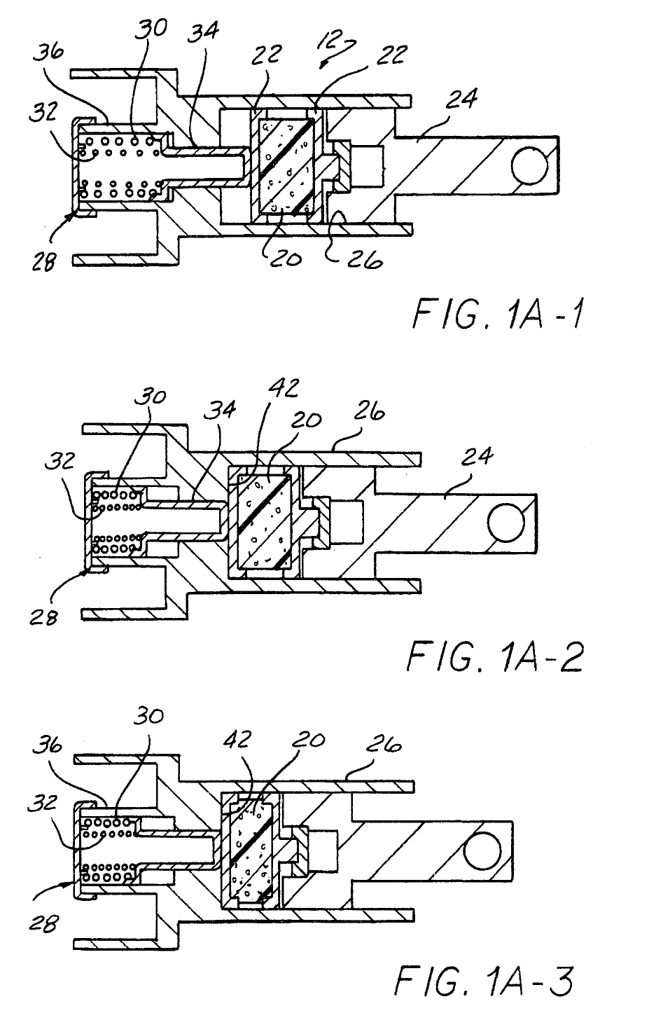

FIGS. 1A-1, 1A-2, and 1A-3 each show a cross-section of a pedal feel emulator mechanism 12 in three successive stages from a no load position (FIG. 1A-1), to a partially compressed condition (FIG. 1A-2) to a full travel position (FIG. 1A-3). In the first stage the hysteresis mechanism 28 and the urethane piece 20 are not loaded. In stage two, when substantial force has been applied, the hysteresis springs 30, 32 begin to compress which causes the plunger 24 to apply a force to the inside of the cylinder 36. The further the springs 30, 32 are compressed the larger the plunger force exerted on the inside walls of the cylinder 36. In stages two and three, the plunger 24 has advance to drive the lead plate 22 against the surface 42 and the micro-cellular urethane elastomeric piece 20 alone is further compressed by continued travel of the plunger 24, greatly increasing the rate of increase of the pedal reaction force.

The mounting bracket 40 for the pedal assembly 10 may be a plastic mounting bracket to allow the integration of the pedal feel emulator mechanism 12 into the lower part of the bracket 40. A plastic mounting bracket has additional advantages in that it costs less and it is much lighter than a traditional stamped steel mounting bracket. It could also be constructed of other materials like die-cast zinc, aluminum or magnesium alloys.

As noted, some foamed elastomers have the inherent characteristics of an exponential increase in force after an initial low linear rate of increase and also have an inherent hysteresis as the restoring force is less than the applying force so that a separate hysteresis generating mechanism may be able to be eliminated to simplify the arrangement.

A problem with the design described above is the inability of the micro-cellular urethane to maintain its performance characteristics while operating under extreme temperatures. Polyurethane material exhibits properties of becoming very stiff under cold temperatures and moderately less stiff under hot temperatures.

An expanded foam silicone elastomer material has advantages for this application. The unique chemistry resulting from the silicon-oxygen polymer backbone is responsible for the extended service temperature capability of silicone rubber. This basic difference between silicone polymers and organic polymers is found in the composition of the polymer backbone chain. This silicon-oxygen linkage is identical to the chemical bond found in highly stable materials such as quartz, glass, and sand, and is responsible for outstanding high temperature performance in silicones.

Silicone foam is commercially available from a number of sources.

The use of a medium density expanded silicone foam can eliminate the need for a separate hysteresis mechanism of the pedal feel emulator mechanism to provide the desired pedal feel to the driver. A medium density expanded silicone rubber piece may be located at the top of a mounting bracket and provided with a preload of one pound by the pedal system. Because of this simplification, the mounting bracket may reduced in size and mass, improving packaging and weight considerations. Eliminating the hysteresis mechanism also reduces the part count for this assembly. Overall this design is more robust, smaller, weighs less and costs significantly less than the first described design.

FIGS. 1B-1E show variations of a mechanical spring-elastomeric piece combination without a separate hysteresis device used to create a simulated pedal feel.

In FIG. 1B, a plunger 44 is arranged to directly compress an elastomeric plastic foam piece 46 in a chamber 48. A Belleville spring 50 is compressed in a second chamber 52 through an abutment with the foamed plastic elastomeric piece 46.

In this case, the material of the foamed plastic elastomeric piece 46 provides the necessary hysteresis.

Both the foamed plastic elastomeric piece 46 and spring 50 provide initial deflection with a low force rate of increase. As the foamed elastomeric piece compresses, its compressibility is reduced and the rate of the spring 50 also increases to create the exponential rate of increase at advanced travel positions.

In FIG. 1C, a shorter foamed plastic elastomeric piece 54, a solid elastomeric piece 56, and a helical compression spring 58 are assembled in the chamber 48 to create a different force-travel characteristic, with a stiffer force-travel relationship.

In FIG. 1D, a single longer foamed elastomeric piece 60 is shown with a stiffer helical compression spring 62 for a softer force-travel characteristic.

In FIG. 1E, a longer helical spring 62 is molded into a longer foamed elastomeric piece 64 for providing yet another characteristic.

Expanded foam silicone elastomeric pieces can be easily configured to meet any load versus-deflection requirement. The hysteresis properties, however, can not be controlled as easily. How much the material springs back (i.e., the hysteresis) is a characteristic directly related to the chemical properties of the spring material. However, the fact that there may be less force than desired on the return stroke of a brake pedal may not be and acute problem. In traffic, for example, the driver may place his or her foot on the pedal to slow the vehicle then immediately take his or her foot off the pedal to apply the accelerator. In this case, return stroke feedback is not really felt by the driver anyway.

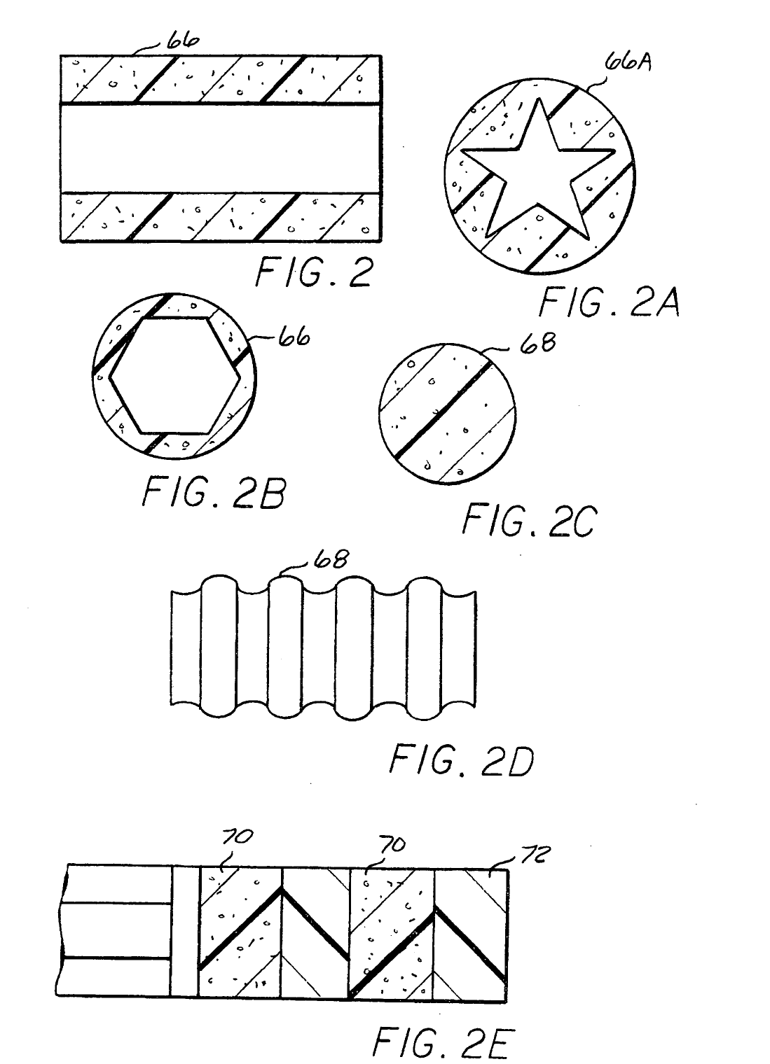

Changing the height (thickness) of the foamed silicone piece allows ready adaption to a desired particular force-travel curve. (See curves A, B, C in FIG. 4 depicting the characteristic curve of three silicone foam pieces of different lengths).

Various other similar elastomer materials which are candidates include open cell foam polyurethane, foamed silicone, foamed fluorocarbon, foamed highly saturated nitrite, foamed methyl acrylate polymer, EDPM foam, Neoprene® foam or Santoprene® foam.

The foamed elastomeric piece can be given various geometric configurations such as to achieve a desired reaction force characteristic, as suggested in U.S. Pat. No. 6,419,215 B1 and 6,540,216B2 both patents hereby incorporated herein by reference. In FIG. 2, a hollow elastomeric piece 66 is shown.

This could take various shapes, such as the star cavity shape in FIG. 2A or hexagonal cavity shown in FIG. 2B.

A solid shape piece 68 such as the circular shape shown in FIG. 2C could be used, which could vary in diameter along its length as shown in FIG. 2D.

The changing shapes produce different force-travel characteristics to enable producing a particular desired force-displacement characteristic. Combinations of two or more foam elastomeric pieces 70 and solid elastomeric pieces 72 can also be used to achieve a particular compressive force characteristics as shown in FIG. 2E.

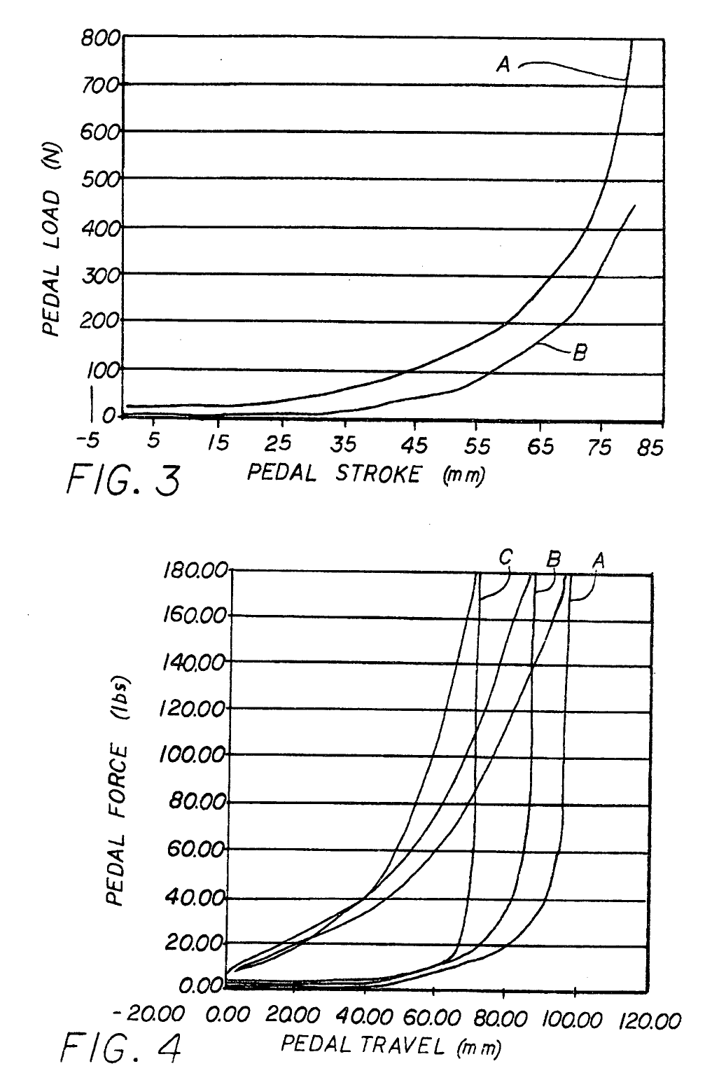

FIG. 5A shows another form of emulator 74 located outside the passenger compartment 76 which uses “dummy” hydraulics and a foamed plastic elastomeric piece 80, in which outflow orifices 82, 84 are successively covered to greatly increase pedal resistance as the pedal travel increases, with foamed plastic elastomeric piece 80 also providing resistance.

FIGS. 5B-5D show other emulator devices which can be located within the passenger compartment.

FIG. 5B shows an emulator 86 including two stage compression of a spring 88 and foam elastomeric piece, 90 by a plunger 92 having two pistons 94, 96 which successively and respectively engage the spring 88 and foamed plastic elastomeric piece 90 to stage the compression of the respective elements.

FIG. 5C shows an in series combination of a spring 98 and foam piece 100 which are both compressed at the same time.

FIG. 5D shows an air spring 102 and elastomeric piece 104 combination.

The spring rates, compressibility, etc., of those elements in each combination can be adjusted empirically to provide any desired force-travel curve required or by conventional analytic methods.

1. An emulator mechanism for an automotive brake pedal operating a brake by wire brake system comprising:
a chamber having a plunger slidable therein drivingly connected to said brake pedal to be moved in advancing and return directions in said chamber by stroking of said brake pedal;
a foamed plastic elastomeric piece disposed in said chamber so as to be compressed by said plunger, whereby a reaction force is exerted on said brake pedal of an increasing rate as said brake pedal approaches the end of its stroke.

2. The emulator mechanism according to claim 1 wherein said foamed plastic elastomeric piece is of a material exhibiting substantial hysteresis when compressed.

3. The emulator mechanism according to claim 2 wherein said foamed plastic elastomeric piece is constructed from micro cellular urethane.

4. The emulator mechanism according to claim 2 wherein said foamed plastic elastomeric piece is constructed of an expanded foam silicone elastomeric material.

5. The emulator mechanism according to claim 1 further including a mechanical spring also compressed by said plunger by advance movement of said brake pedal.

6. The emulator mechanism according to claim 1 wherein a separate hysteresis device is also included operated by advance of said plunger.

7. The emulator mechanism according to claim 1 wherein a gas spring is also included compressed by advance of said plunger.

8. The emulator mechanism according to claim 5 wherein said spring is embedded in said foamed plastic elastomeric piece to also be compressed by advance of said plunger.

9. The emulator mechanism according to claim 1 wherein a solid elastomeric piece is disposed in said chamber to also be compressed by advance of said plunger.

10. The emulator mechanism according to claim 9 wherein a mechanical spring is disposed in said chamber to also be compressed by advance of said plunger.

11. The emulator mechanism according to claim 9 wherein a plurality of foamed plastic and solid elastomeric pieces are compressed by advance of said plunger.

12. The emulator mechanism according to claim 1 wherein a spring member is disposed in said chamber to also be compressed by advance of said plunger.

13. The emulator mechanism according to claim 12 wherein said plunger has two separated pistons thereon, each piston engaging a respective one of said foamed plastic elastomeric piece and said spring member.

14. The emulator mechanism according to claim 13 wherein said two pistons begin to compress said respective engaged foamed plastic elastomeric piece and spring member at different points along the advancing travel of said plunger.

15. The emulator mechanism according to claim 14 wherein said spring device is a gas spring.

16. The emulator mechanism according to claim 14 wherein said spring device is a mechanical spring.

17. A brake feel emulator mechanism for an automotive brake pedal operating a brake by wire system comprising:
a chamber having a plunger slidable therein drivingly connected to said brake pedal to be movable in advancing and return directions; and,
said plunger having two spaced apart pistons mounted therein; a separator resiliently compressible member associated with each piston to be separately compressed by advance of said plunger.

18. The brake feel emulator mechanism according to claim 17 wherein said resistance members have differing compressibility characteristics.

19. The brake feel emulator mechanism according to claim 17 wherein said pistons begin to compress their respective resistance members at different points along the advance travel of said plunger.

20. The brake feel emulator mechanism according to claim 17 wherein at least one of said members comprises a foamed plastic elastomeric piece.

21. A method of emulating a conventional brake pedal feel of a brake pedal used to operate a brake by wire brake system comprising:
engaging a plunger with said brake pedal to be moved in advancing or return direction therewith;
compressing a resiliently compressible member comprised of a piece of foamed plastic elastomeric with said plunger, said foamed plastic elastomeric piece having significant hysteresis and a variable rate of compression due to collapse of voids in said elastomeric piece.

22. The method according to claim 23 wherein said foamed plastic elastomeric piece is shaped to achieve a particular force displacement characteristic of a conventional brake system over the course of said plunger advancing movement.

23. The method according to claim 22 compressing another resiliently compressible member by said plunger advancing movement.

24. The method according to claim 22 wherein both of said foamed plastic elastomeric piece and said another member are simultaneously compressed by said plunger movement.

25. The method according to claim 22 wherein said foamed plastic elastomeric piece and said another member are compressed in stages when said plunger is stroked.

26. The method according to claim 22 wherein a separate hysteresis device is also operated by said plunger movement.
